(19) United States
(12) Patent Application Publication
(10) Pub. No.: US 2018/0067507 A1
(43) Pub. Date: Mar. 8, 2018

(54) RELATIVE SENSOR BASED THERMAL MANAGEMENT

(71) Applicant: Microsoft Technology Licensing, LLC, Redmond, WA (US)

(72) Inventors: Gregory Allen Nielsen, Kirkland, WA (US); Rajagopal K. Venkatachalam, Sammamish, WA (US); Ryan Charles Smith, Redmond, WA (US); Mark Adrian Hughes, Redmond, WA (US)

(21) Appl. No.: 15/261,850

(22) Filed: Sep. 9, 2016

Related U.S. Application Data
(60) Provisional application No. 62/383,322, filed on Sep. 2, 2016.

(51) Int. Cl. G05D 23/19; G06F 1/20; G05B 15/02

(52) U.S. Cl. CPC G05D 23/1917; G05B 15/02; G06F 1/206

(57) ABSTRACT

Cooling of an electronic device is described herein. A sensor of the electronic device is located at a first position and is associated with a second position. The sensor determines a temperature at the first position. A processor in communication with the sensor calculates a relative temperature for the second position based on the determined temperature at the first position. The processor determines an expected temperature at the second position based on the calculated relative temperature for the second position. The determined expected temperature at the second position is compared to a predetermined temperature for the second position. At least one component of the electronic device is controlled when the determined expected temperature for the second position is greater than the predetermined temperature for the second position.

### PRIORITY

This application claims the benefit of U.S. Provisional Patent Application Ser. No. 62/383,322, filed on Sep. 2, 2016, which is hereby incorporated by reference in its entirety.

### BRIEF DESCRIPTION OF THE DRAWINGS

For a more complete understanding of the disclosure, reference is made to the following detailed description and accompanying drawing figures, in which like reference numerals may be used to identify like elements in the figures.

FIG. 1 depicts a top view of a computing device including an example of a thermal management system.

FIG. 2 is a flow diagram of a method for cooling an electronic device in accordance with one example.

FIG. 3 is a flowchart of transmission of calculated temperatures to parts of a thermal management system in accordance with one example.

FIG. 4 is a block diagram of a computing environment in accordance with one example for implementation of the disclosed methods or one or more electronic devices.

While the disclosed devices, systems, and methods are representative of embodiments in various forms, specific embodiments are illustrated in the drawings (and are hereafter described), with the understanding that the disclosure is intended to be illustrative, and is not intended to limit the claim scope to the specific embodiments described and illustrated herein.

### DETAILED DESCRIPTION

Current microprocessor design trends include designs having an increase in power, a decrease in size, and an increase in speed. This results in higher power in a smaller, faster microprocessor. Another trend is towards lightweight and compact electronic devices. As microprocessors become lighter, smaller, and more powerful, the microprocessors also generate more heat in a smaller space, making thermal management a greater concern than before.

The purpose of thermal management is to maintain the temperature of a device within a moderate range. During operation, electronic devices dissipate power as heat that is to be removed from the device. Otherwise, the electronic device will get hotter and hotter until the electronic device is unable to perform efficiently. When overheating, electronic devices run slowly and dissipate power poorly. This can lead to eventual device failure and reduced service life. Also, unless the power dissipated by the electronic device as heat is removed, outside surface touch areas of the electronic device (e.g., hotspot locations on a housing) increase in temperature.

As computing devices get smaller (e.g., thinner), thermal management becomes more of an issue. Heat may be dissipated from a computing device using forced and natural convection, conduction, and radiation as a way of cooling the computing device as a whole and a processor operating within the computing device. For forced convection, a computing device may include a number of fans used to move air through the computing device and cool one or more heat generating components of the computing device.

A thermal management system of the prior art may use sensors to track temperatures within the computing device (e.g., corresponding to components within the computing device and/or positions on the motherboard) and increases a speed of at least one of the fans and/or decreases an operating frequency for at least one heat generating component of the computing device when a tracked temperature approaches or exceeds a temperature limit. Higher fan speed results in more cooling and thus a lower temperature for the corresponding component and better system performance. Lower operating frequency results in less heat being generated and thus a lower temperature for the corresponding component.

A temperature limit of the prior art may be a relative temperature limit. For example, a sensor tracks a temperature for a position on the motherboard of the electronic device, and the temperature limit corresponds to the position on the motherboard. The position on the motherboard is, for example, opposite a hotspot location on the housing. The position on the motherboard may be cooled in a number of different ways (e.g., radiation, conduction, and convection), such that the temperature at the position on the motherboard is not the same as the temperature at the hotspot location on the housing. The temperature at the position on the motherboard thus has an offset and rises faster than the corresponding hotspot location. This may lead to a premature throttling of at least one heat generating component (e.g., with a decrease in operating frequency), a premature increase in fan speed, or a combination thereof when the temperature for the position on the motherboard is used to track the hotspot.

Disclosed herein are apparatuses, systems, and methods for controlling speeds of fans and/or frequencies of heat generating components of an electronic device based on absolute hotspot location temperature thresholds to provide optimal thermal management. A raw sensor temperature is read via a processor (e.g., a microcontroller), and the microcontroller applies a relative temperature calibration pre-determined via a correlation to the hotspot location. In one example, the relative temperature calibration is linear and includes pre-determined slope and offset.

With the relative temperature calibration, the microcontroller calculates a relative temperature. The microcontroller then applies an averaging (e.g., averaging logic, formula, algorithm) to calculate an average temperature for the hotspot location. Since the temperature rise of the hotspot location may be non-linear, the averaging applied by the microcontroller may be an exponential weighted moving averaging. The exponential weighted moving averaging may use an averaging constant t that is determined based on lab testing for the sensor to best align with a rate the hotspot location temperature increases. The calculated relative temperature and the calculated average temperature for the hotspot location are transmitted to software and/or hardware of the thermal management system. For example, the calculated relative temperature and the calculated average temperature for the hotspot location are transmitted to thermal management algorithms in the operating system (OS) or firmware to be executed by the microcontroller or another processor.

The relative temperature calibration and the averaging provided by the present examples allow trip points (e.g., temperature thresholds or limits) to be stored in, for example, the microcontroller, BIOS/UEFI, and/or OS level drivers as absolute target temperatures. In the prior art, when relative temperature limits change (e.g., for each new product and/or new software updates), the relative temperature limits are to be input in multiple locations. The relative temperature calibration and the averaging provided by the present examples may thus prevent the engineer from making errors in the input of the trip points, as only the absolute target temperatures, which infrequently change, are input. Further, the relative temperature calibration and the averaging provided by the present examples allow the sensor to better track the temperature of the outside touch area of the electronic device.

As an example, the improved heat dissipation from a computing device may be implemented by a method for cooling an electronic device. The method includes determining, by a sensor of the electronic device located at a first position and associated with a second position, a temperature at the first position. A processor in communication with the sensor calculates a relative temperature for the second position based on the determined temperature at the first position. The processor determines an expected temperature at the second position based on the calculated relative temperature for the second position. The determined expected temperature at the second position is compared to a predetermined temperature for the second position. At least one component of the electronic device is controlled when the determined expected temperature for the second position is greater than the predetermined temperature for the second position.

Such heat dissipation apparatuses or systems have several potential end-uses or applications, including any electronic device having an active cooling component (e.g., fan). For example, the heat dissipation apparatus may be incorporated into personal computers, server computers, tablet or other handheld computing devices, laptop or mobile computers, gaming devices, communications devices such as mobile phones, multiprocessor systems, microprocessor-based systems, set top boxes, programmable consumer electronics, network PCs, minicomputers, mainframe computers, or audio or video media players. In certain examples, the heat dissipation apparatus may be incorporated within a wearable electronic device, where the device may be worn on or attached to a person's body or clothing. The wearable device may be attached to a person's shirt or jacket; worn on a person's wrist, ankle, waist, or head; or worn over their eyes or ears. Such wearable devices may include a watch, heart-rate monitor, activity tracker, or head-mounted display.

Using one or more of these features described in greater detail below, improved heat dissipation may be provided for the electronic device. With the improved heat dissipation feature, a more powerful microprocessor may be installed for the electronic device, a thinner electronic device may be designed, a higher processing speed may be provided, the electronic device may be operated at a higher power for a longer period of time, or any combination thereof may be provided when compared to a similar electronic device without one or more of the improved heat dissipation features. In other words, the heat dissipation features described herein may provide improved thermal management for an electronic device such as a mobile phone, tablet computer, or laptop computer.

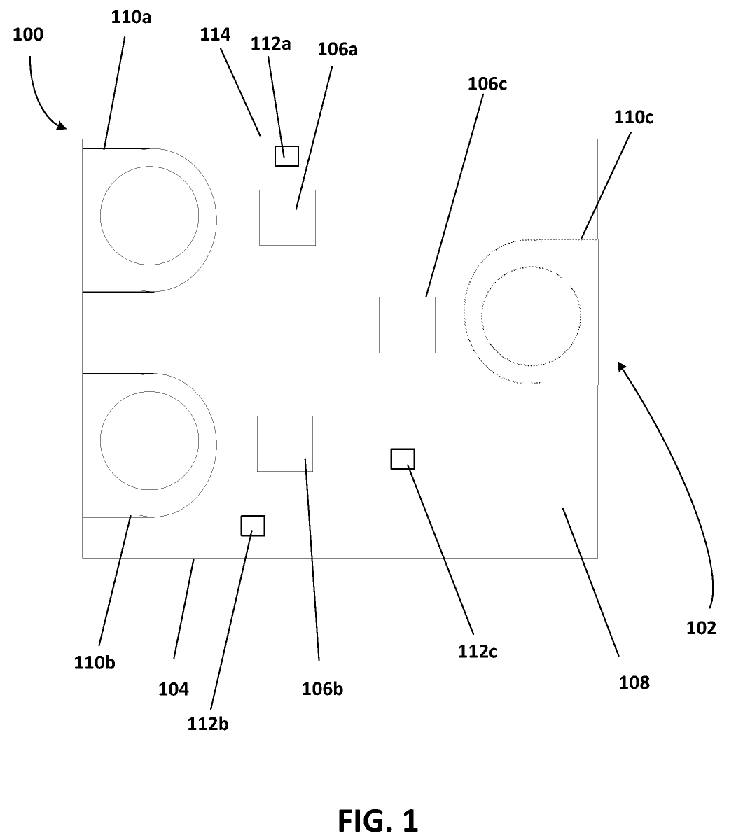

FIG. 1 shows a top view of a computing device 100 including an example of a thermal management system 102. The computing device 100 may be any number of computing devices including, for example, a personal computer, a server computer, a tablet or other handheld computing device, a laptop or mobile computer, a communications device such as a mobile phone, a multiprocessor system, a microprocessor-based system, a set top box, a programmable consumer electronic device, a network PC, a minicomputer, a mainframe computer, or an audio and/or video media player.

The computing device 100 includes a housing 104 that supports at least the thermal management system 102 and one or more heat generating components or heat generating devices 106. The one or more heat generating components 106 may be any number of electrically powered devices including, for example, a processor, memory, a power supply, a graphics card, a hard drive, or another electrically powered device. The one or more heat generating components 106 may be supported by the housing 104 via, for example, a printed circuit board (PCB) 108 (e.g., a motherboard) attached to and/or supported by the housing 104. The one or more heat generating components 106 are in communication with each other and/or other electrical devices or components (e.g., fans) of the computing device 100 via the PCB 108, for example. The computing device 100 may include a number of components not shown in FIG. 1 (e.g., a hard drive, a power supply, connectors).

Three heat generating components 106 (e.g., first heat generating component 106a, second heat generating component 106b, and third heat generating component 106c) are shown in the example of FIG. 1. More or fewer heat generating components 106 may be included in the computing device. In one example, the heat generating component 106a is a processor, the heat generating component 106b is a graphics card, and the heat generating component 106c is a memory. In other examples, one or more of the heat generating components 106a, 106b, and 106c represent different components within the computing device 100 (e.g., a hard drive, a power supply, or another processor).

The thermal management system 102 includes one or more fans 110 to actively cool the one or more heat generating components 106, respectively, moving heat out of the computing device 100 via vents in the housing 104 of the computing device 100. The one or more fans 110 may rotate on any number of types of bearings including, for example, sleeve bearings, rifle bearings, ball bearings, fluid bearings, magnetic bearings, or another type of bearing. The one or more fans 110 may be sized and/or may rotate at a speed based on the heat generating component 106 to be cooled (e.g., based on the heat generated by the heat generating component 106 to be cooled). Each of the one or more fans 110 may be the same type of fan, or different types of fans may be used.

In the example shown in FIG. 1, the thermal management system 102 includes three fans 110 (e.g., first fan 110a, second fan 110b, and third fan 110c) to cool the three heat generating components 106a, 106b, and 106c, respectively. The thermal management system 102 may include more or fewer fans 110. The thermal management system 102 may include additional components (e.g., heat sinks and/or phase change devices) to aid in the removal of heat from the computing device 100. For example, the thermal management system 102 may include phase change devices (e.g., heat pipes and/or vapor chambers) physically attached or adjacent to a respective heat generating component 106 and a respective fan 110.

The thermal management system 102 also includes one or more sensors 112 that monitor temperatures within the housing 104. The one or more sensors 112 may be any number of different types of temperature sensors including, for example, a thermocouple, a resistance temperature detector (RTD) (e.g., a resistance wire RTD or a thermistor), or another type of temperature sensor. All of the one or more sensors 112 may be the same type of sensor, or different types of sensors may be used within the computing device 100.

As shown in the example of FIG. 1, the thermal management system 102 may include three sensors 112 (e.g., a first sensor 112a, a second sensor 112b, and a third sensor 112c). The first sensor 112a monitors a temperature at a first position within the housing 104, the second sensor 112b monitors a temperature at a second position within the housing 104, and the third sensor 112c monitors a temperature at a third position within the housing 104. At least some positions of the first position, the second position, and the third position may be on the PCB 108. In one example, the first position, the second position, and the third position are associated with the first heat generating device 106a, the second heat generating device 106b, and the third heat generating device 106c, respectively, and respective hotspots on the housing 104.

Each of the first sensor 112a, the second sensor 112b, and the third sensor 112c may be positioned on the PCB 108 to best track a temperature of a respective hotspot. For example, operation of the first heat generating component 106a may at least partially produce a hotspot 114 on the housing 104. The first sensor 112a is disposed in a position (e.g., the first position) on the PCB 108 to best track the temperature at the hotspot 114 on the housing 104. The first position may be determined in any number of ways including, for example, experimentally. In another example, the first position, the second position, and the third position are located on the PCB 108 at shortest distances from a first hotspot (e.g., the hotspot 114), a second hotspot, and a third hotspot on the housing 104, respectively. In one example, the first position, the second position, and the third position are opposite the first hotspot, the second hotspot, and the third hotspot, respectively. More or fewer sensors may be provided to track more or fewer hotspots on the housing 104.

In one example, the first sensor 112a, the second sensor 112b, and the third sensor 112c are positioned on or adjacent to the first heat generating component 106a, the second heat generating component 106b, and the third heat generating component 106c, respectively. In one example, a sensor 112 monitors a temperature at a position within the computing device 100 not at or adjacent to one of the heat generating components 106. For example, the sensor 112 may monitor a temperature of a component of the thermal management system 102 (e.g., at a position on a phase change device such as a heat pipe). The thermal management system 102 may include more or fewer sensors 112.

All of the sensors 112 within the computing device 100 provide live closed-loop feedback to the thermal management system 102. For example, the thermal management system 102 includes a processor (e.g., a microcontroller; one of the heat generating components 106 or another processor within or outside the computing device 100). The processor 106a, for example, receives the live temperatures from the sensors 112a, 112b, and 112c and controls the fans 110a, 110b, and 110c and/or the heat generating components 106a, 106b, and 106c based on the methods described below to avoid both under cooling, which reduces system performance and component life expectancy, and over cooling.

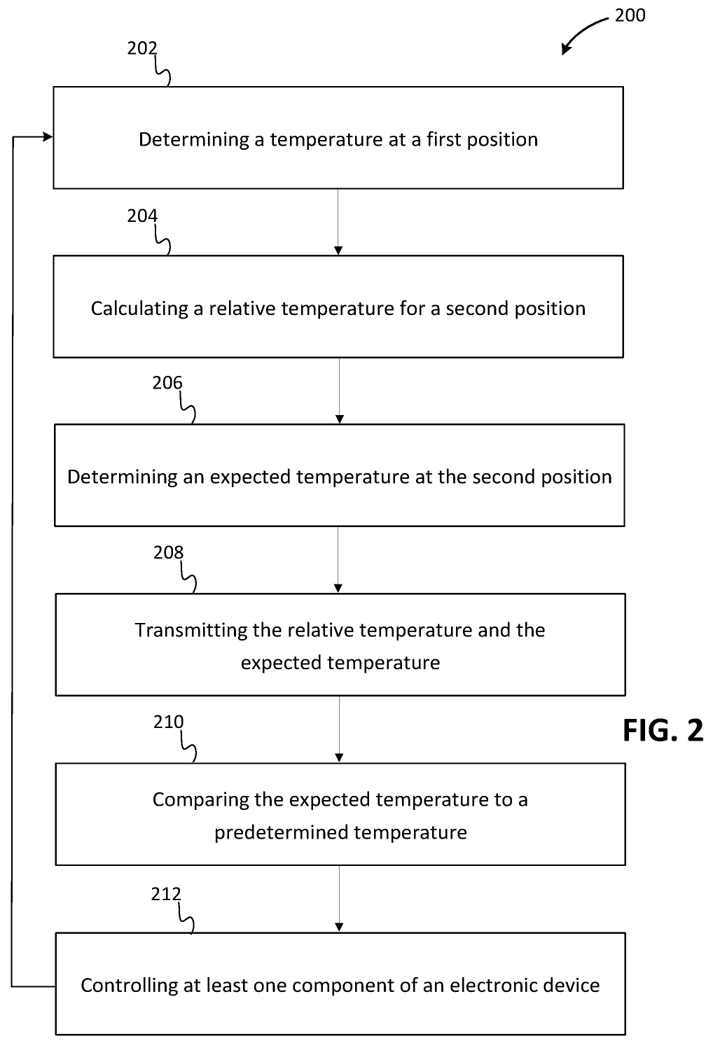

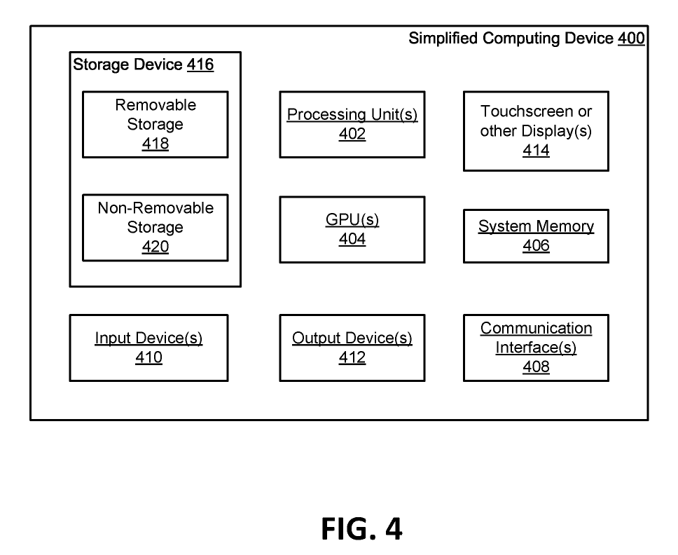

FIG. 2 shows a flowchart of one example of a method 200 for cooling an electronic device. The computing device may be a computing device shown in FIGS. 1 and 4 or may be another computing device. The method 200 is implemented in the order shown, but other orders may be used. Additional, different, or fewer acts may be provided. Similar methods may be used for transferring heat.

The electronic device may be any number of electronic devices including, for example, a personal computer, a server computer, a tablet or other handheld computing device, a laptop or mobile computer, a communications device such as a mobile phone, a multiprocessor system, a microprocessor-based system, a set top box, a programmable consumer electronic device, a network PC, a minicomputer, a mainframe computer, or an audio and/or video media player. The electronic device includes one or more heat generating devices to be cooled. For example, the one or more heat generating devices may be any number of electrically powered devices including, for example, a processor, memory, a power supply, a graphics card, a hard drive, or another electrically powered device. The electronic device may also include one or more fans to actively cool heat generating devices within the electronic device. In one example, the electronic device includes a number of sensors that correspond to a number of hotspots, respectively. The hotspots may be formed by heat generated by the heat generating devices and transferred to the hotspots, respectively.

In one example, at least one of the heat generating devices is a processor. In another example, none of the heat generating devices is the processor (e.g., the processor is located outside the electronic device, and data is transmitted from/to the sensors to/from the processor via a wired and/or wireless connection). The processor may be configured by hardware, software, firmware, or any combination thereof.

In act 202, a sensor of the electronic device determines a temperature at a first position. The sensor is located at the first position and is associated with a second position. In one example, the first position is a position on a PCB (e.g., a motherboard; a first motherboard position) of the electronic device, and the second position is a position at a housing of the electronic device (e.g., a first hotspot position). For example, the second position may be a hotspot on an outer surface of the housing, and the first position is a position on the motherboard of the electronic device that best tracks a temperature of the hotspot. An optimal position for the first position may be determined with a simulation and/or by experimentation. In one example, the first position is a position on the motherboard opposite the second position at the housing of the electronic device.

The sensor provides live temperature feedback (e.g., in degrees Celsius, Fahrenheit, or Kelvin) to the processor via a circuit board, a wired connection, a wireless connection, or any combination thereof. In one example, the sensor determines the temperature at the first motherboard position, for example, at a plurality of time points. The sensor may determine the temperature at the first motherboard position at a predetermined interval (e.g., every 0.1 s, 0.5 s, 1.0 s) or may determine the temperature at the first motherboard position continuously. For example, the sensor may determine a first temperature, a second temperature, and a third temperature (e.g., a plurality of temperatures) at a first time point, a second time point, and a third time point (e.g., a plurality of time points), respectively, at the first motherboard position. More temperatures may be determined at additional time points. At least a subset of the determined temperatures may be stored in a memory within and/or outside of the electronic device.

In act 204, the processor, which is in communication with the sensor, calculates a relative temperature for the second position (e.g., the first hotspot position) based on the determined temperature at the first position (e.g., the first motherboard position). In one example, the processor calculates the relative temperature for the first hotspot position based on at least two predetermined values. For example, the processor identifies the at least two predetermined values for a correlation between the determined temperature at the first motherboard position and the calculated relative temperature for the first hotspot position. The at least two predetermined values may represent a slope and an offset, and the correlation may be a linear correlation. In one example, to calculate the relative temperature for the first hotspot position, the processor multiplies the determined temperature at the first motherboard position by the identified slope and adds the identified offset. In other examples, more predetermined values may be identified for higher order correlations.

In one example, the processor calculates relative temperatures for the first hotspot position based on the plurality of temperatures determined by the sensor at the first motherboard position at the plurality of time points, respectively. At least a subset of the calculated relative temperatures may be stored in the memory within and/or outside of the electronic device.

In one example, the memory or another memory stores pairs of predetermined values. Each of the pairs of predetermined values represents a respective linear correlation of the temperature at the first motherboard position with the calculated relative temperature for the first hotspot position. The different pairs of predetermined values may correspond to different operating conditions within the electronic device, different sensors, different hotspot positions, or any combination thereof. The processor identifies or selects one of the pairs of predetermined values stored in the memory based on a current operating condition of the electronic device, such as, for example, a mode in which a battery of the electronic device is charging, the sensor determining the temperature at the first position, the position of the hotspot for which the relative temperature is calculated in act 204 (e.g., the first hotspot position), or any combination thereof.

The pairs of predetermined values stored in the memory may be based on experimental data, simulation data, or a combination thereof. For example, the slope and the offset for the linear correlation between the first motherboard position and the first hotspot position are experimentally determined, the processor generates or identifies the pair of predetermined values including the experimentally determined slope and offset, and the memory stores the generated pair of predetermined values. In one example, a number of pairs of predetermined values (e.g., including a slope and an offset) corresponding to the first motherboard position and the first hotspot position are generated or identified by the processor and stored by the memory for a number of operating conditions for the electronic device, respectively.

In act 206, the processor determines an expected temperature at the second position (e.g., the first hotspot position) based on the calculated relative temperature for the second position. In one example, the processor determines the expected temperature by determining an average temperature at the first hotspot position. For example, the processor determines the average temperature at the first hotspot position using the temperatures determined by the sensor at the first motherboard position, at the first time point, the second time point, the third time point, etc. In one example, the processor determines the average temperature at the first hotspot position using an exponential weighted moving average formula based on the determined temperatures at the first motherboard position at a number of different time points (e.g., five different time points). The exponential weighted moving average formula may be used due to the temperature rises at the first motherboard position and the first hotspot position, respectively, being non-linear. As part of the exponential weighted moving average formula, an averaging constant τ may be determined in a number of ways including, for example, experimentally. The experimentally determined averaging constant t may be determined for the sensor to best align with a rate at which the temperature at the first hotspot position increases. Additional and/or different averaging constants τ for different sensor/hotspot combinations may be determined and stored in the memory or another memory.

The processor may determine the expected temperature at the first hotspot position and/or the average temperature at the first hotspot position in any number of other ways. For example, the processor may determine the average temperature at the first hotspot position using neural networks, normalization, other averaging, or any combination thereof. In one example, the processor identifies the relative temperature for the first hotspot position calculated in act 204 as the expected temperature at the first hotspot position without any averaging.

In act 208, the relative temperature for the first hotspot position calculated in act 204 and the expected temperature (e.g., the calculated average temperature) at the first hotspot position determined in act 206 are transmitted to software and/or hardware of a thermal management system of the electronic device (e.g., participants in thermal management algorithms).

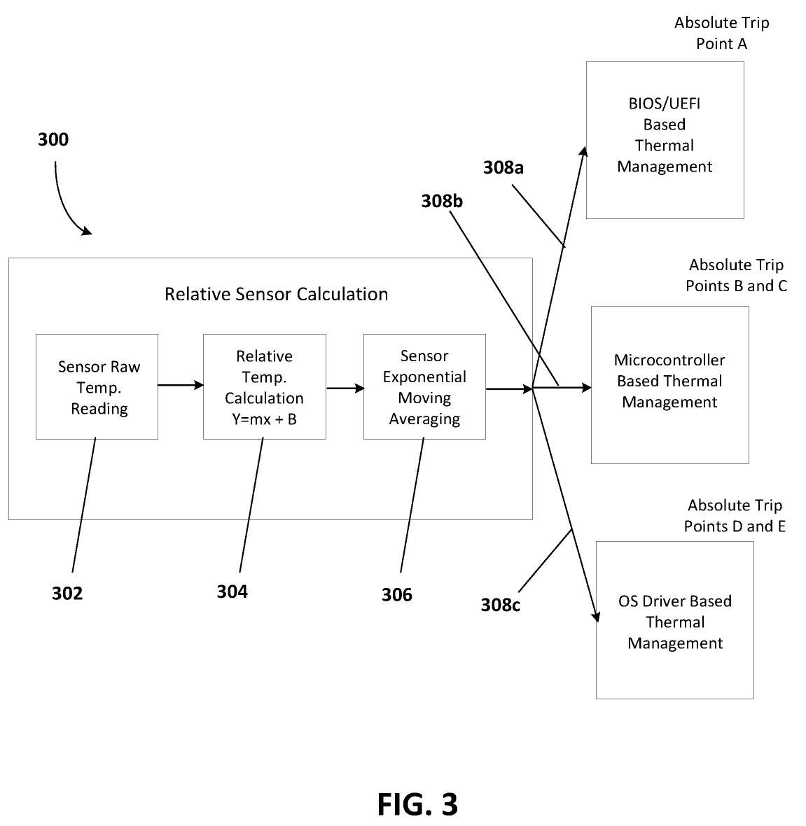

FIG. 3 shows a flowchart of one example of transmission of the calculated relative temperature and the calculated average temperature. FIG. 3 illustrates a relative sensor calculation algorithm 300 that includes acts 302-306 corresponding to examples of acts 202-206 discussed above, respectively. For example, in act 302, a raw temperature is read from a sensor. In act 304, a relative temperature is calculated using a linear relationship (e.g., y=mx+b). In act 306, an average temperature is calculated using an exponential weighted moving averaging based on the relative temperature calculated in act 302 and relative temperatures previously calculated for the sensor. In act 308, the relative temperature calculated in act 304 and the average temperature calculated in act 306 are transmitted to participants in the thermal management algorithms. As shown in the example of FIG. 3, in act 308a, the relative temperature and the average temperature are transmitted to BIOS and/or the Unified Extensible Firmware Interface (UEFI); in act 308b, the relative temperature and the average temperature are transmitted to a microcontroller; and in act 308c, the relative temperature and the average temperature are transmitted to an operating system (OS) driver. The BIOS, the UEFI, the microcontroller, the OS driver, other software and/or hardware within the electronic device, or any combination thereof perform thermal management functions within the thermal management system of the electronic device and may use the transmitted relative temperature and average temperature as part of the thermal management functions.

As shown in the example of FIG. 3, different absolute trip points may be stored at and/or retrieved by the participants in the thermal management algorithms (e.g., the BIOS, the UEFI, the microcontroller, the OS driver, other software and/or hardware within the electronic device). For example, absolute trip point A are stored in and/or referenced by the BIOS and the UEFI; absolute trip points B and C are stored in and/or referenced by the microcontroller; and absolute trip points D and E are stored in and/or referenced by the OS driver.

In act 210, the determined expected temperature at the second position is compared to a predetermined temperature for the second position (e.g., the first hotspot position). In one example, the comparison includes calculation of a difference between the determined expected temperature at the second position and the predetermined temperature for the second position.

The predetermined temperature for the first hotspot position is an absolute temperature for the first hotspot position that is not to be exceeded (e.g., an absolute trip point or an absolute temperature threshold). The predetermined temperature is stored in the memory or another memory and is predetermined based on any number of factors including, for example, comfort of a user of the electronic device. The predetermined temperature may be one of a plurality of predetermined temperatures stored in the memory or the other memory. The plurality of predetermined temperatures may correspond to different hotspot positions on the housing of the electronic device, for example, and/or different operating conditions of the electronic device. For example, the absolute trip point for the first hotspot position, depending on where the first hotspot position is located on the housing of the electronic device, may be different when the electronic device is charging compared to when the electronic device is not charging.

In act 212, at least one component of the electronic device is controlled when the determined expected temperature for the second position (e.g., the calculated average temperature for the first hotspot position) is greater than the predetermined temperature for the second position (e.g., the absolute trip point for the first hotspot position). For example, the processor or another processor may generate a control signal and transmit the control signal to the at least one component of the electronic device based on the comparison of act 210. The transmitted control signal instructs the at least one component of the electronic device to take any number of actions.

In one example, when the determined expected temperature for the first hotspot temperature is greater than, or greater than or equal to the absolute trip point for the first hotspot position, the processor or another processor may increase a speed of at least one of the fans, decrease an operating frequency (e.g., throttle) of at least one of the heat generating devices (e.g., the processor), limit (e.g., throttle) a charge current to at least one of the heat generating devices (e.g., a battery), or any combination thereof. The processor or the other processor may gradually throttle the at least one heat generating device, may severely throttle the at least one heat generating device, or may shut down the at least one heat generating device. By increasing the speed of at least one of the fans and/or decreasing the operating frequency of at least one of the heat generating devices, the temperature at the first hotspot position may be decreased.

In one example, the processor or the other processor determines whether to gradually throttle, severely throttle, or shut down the at least one heat generating device based on an amount the determined expected temperature for the first hotspot position is greater than the absolute trip point for the first hotspot position. For example, if the amount is less than or equal to one degree Fahrenheit, the processor may gradually throttle the at least one heat generating device by 10% or less; if the amount is less than or equal to two degrees Fahrenheit but more than one degree Fahrenheit, the processor may severely throttle the at least one heat generating device by 50% or more; and if the amount is greater than two degrees Fahrenheit, the processor may shut down the at least one heat generating device. Other throttling percentages and temperature thresholds for the different actions may be used. In another example, the processor or the other processor determines how much to increase the speed of the at least one fan based on the amount the determined expected temperature for the first hotspot position is greater than the absolute trip point for the first hotspot position.

After act 212, the method 200 may return to act 202. The method may be a closed loop in that a thermal management system of the electronic device is continuously monitoring the temperatures calculated for hotspots on the housing of the electronic device or is monitoring the temperatures calculated for the hotspots at a predetermined interval.

The method 200 of FIG. 2 may be performed for a number of sensors in parallel. For example, the memory may store pairs of predetermined values (e.g., a slope and an offset) for a number of different sensors associated with a number of different hotspots, respectively. Additionally, each of the sensors may correspond to a number of different hotspots. For a particular hotspot, the processor or another processor may weight the calculated relative temperatures based on distances between the sensors and the hotspot and/or other parameters, respectively, and add the weighted temperatures to determine the expected temperature at the hotspot.

In one example, the sensor described in act 202 above is a first sensor that is disposed at the first motherboard position, and a second sensor is disposed at a second motherboard position that is different than the first motherboard position. The second sensor determines a temperature at the second motherboard position. The relative temperature calculated in act 204 is a first relative temperature, and the processor or another processor calculates a second relative temperature for the first hotspot position. The second relative temperature is calculated based on the determined temperature at the second motherboard position and a predetermined slope and offset for the linear correlation between the determined temperature at the second motherboard position and second relative temperature at the first hotspot position. The average temperature calculated in act 206 is a first average temperature, and the processor or another processor may calculate a second average temperature based on the second relative temperature. The second relative temperature and the second average temperature are transmitted to the participants in the thermal management algorithms. The expected temperature at the first hotspot position may be determined based on the first relative temperature and the second relative temperature and/or the first average temperature and the second average temperature.

The absolute trip points being stored in the BIOS, the UEFI, the microcontroller, the OS driver, the other software and/or hardware within the electronic device, or any combination thereof do not change often. For example, a hotspot temperature that is not to be exceeded (e.g., an absolute trip point) at a position on an outer surface of the housing may not change or may change infrequently for different hardware versions of the electronic device and/or software updates. Relative trip points, however, may change with different hardware and/or software versions of the electronic device frequently, as different layouts within different versions of electronic devices (e.g., different sized gaps, different components included within the electronic device, more or fewer fans included within the electronic device) may change the amount of heat that reaches the position on the outer surface of the housing. An engineer may thus need to manage relative trip points every engineering cycle in a number of different locations (e.g., the BIOS and the OS driver). The use of absolute trip points decreases the risk that the engineer will make a mistake and forget to update one of the trip points.

With reference to FIG. 4, a thermal management system, as described above, may be incorporated within an exemplary computing environment 400. The computing environment 400 may correspond with one of a wide variety of computing devices, including, but not limited to, personal computers (PCs), server computers, tablet and other handheld computing devices, laptop or mobile computers, communications devices such as mobile phones, multiprocessor systems, microprocessor-based systems, set top boxes, programmable consumer electronics, network PCs, minicomputers, mainframe computers, or audio or video media players. For example, the heat dissipating apparatus is incorporated within a computing environment having an active cooling source (e.g., fans).

The computing environment 400 has sufficient computational capability and system memory to enable basic computational operations. In this example, the computing environment 400 includes one or more processing units 402, which may be individually or collectively referred to herein as a processor. The computing environment 400 may also include one or more graphics processing units (GPUs) 404. The processor 402 and/or the GPU 404 may include integrated memory and/or be in communication with system memory 406. The processor 402 and/or the GPU 404 may be a specialized microprocessor, such as a digital signal processor (DSP), a very long instruction word (VLIW) processor, or other microcontroller, or may be a general purpose central processing unit (CPU) having one or more processing cores. The processor 402, the GPU 404, the system memory 406, and/or any other components of the computing environment 400 may be packaged or otherwise integrated as a system on a chip (SoC), application-specific integrated circuit (ASIC), or other integrated circuit or system.

The computing environment 400 may also include other components, such as, for example, a communications interface 408. One or more computer input devices 410 (e.g., pointing devices, keyboards, audio input devices, video input devices, haptic input devices, or devices for receiving wired or wireless data transmissions) may be provided. The input devices 410 may include one or more touch-sensitive surfaces, such as track pads. Various output devices 412, including touchscreen or touch-sensitive display(s) 414, may also be provided. The output devices 412 may include a variety of different audio output devices, video output devices, and/or devices for transmitting wired or wireless data transmissions.

The computing environment 400 may also include a variety of computer readable media for storage of information such as computer-readable or computer-executable instructions, data structures, program modules, or other data. Computer readable media may be any available media accessible via storage devices 416 and includes both volatile and nonvolatile media, whether in removable storage 418 and/or non-removable storage 420. Computer readable media may include computer storage media and communication media. Computer storage media may include both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the processing units of the computing environment 400.

While the present claim scope has been described with reference to specific examples, which are intended to be illustrative only and not to be limiting of the claim scope, it will be apparent to those of ordinary skill in the art that changes, additions and/or deletions may be made to the disclosed embodiments without departing from the spirit and scope of the claims.

The foregoing description is given for clearness of understanding only, and no unnecessary limitations should be understood therefrom, as modifications within the scope of the claims may be apparent to those having ordinary skill in the art.

In a first embodiment, a method for cooling an electronic device includes determining, by a sensor of the electronic device located at a first position and associated with a second position, a temperature at the first position. The method also includes calculating, by a processor in communication with the sensor, a relative temperature for the second position based on the determined temperature at the first position. The method includes determining, by the processor, an expected temperature at the second position based on the calculated relative temperature for the second position. The method also includes comparing the determined expected temperature at the second position to a predetermined temperature for the second position, and controlling at least one component of the electronic device when the determined expected temperature for the second position is greater than the predetermined temperature for the second position.

In a second embodiment, with reference to the first embodiment, the determined temperature at the first position is a first temperature determined at a first time point. The method further includes determining, by the sensor, a second temperature at the first position at a second time point. The second time point is after the first time point. Determining the expected temperature at the second position includes calculating, by the processor, an average temperature for the second position based on the first temperature and the second temperature at the first position.

In a third embodiment, with reference to the second embodiment, calculating the average temperature for the second position includes calculating an exponential weighted moving average for the second position.

In a fourth embodiment, with reference to the first embodiment, the sensor is a first sensor, and the calculated relative temperature is a first calculated relative temperature. The method further includes determining, by a second sensor of the electronic device located at a third position and associated with the second position, a temperature at the third position. The method also includes calculating a second relative temperature for the second position based on the determined temperature at the third position. Determining the expected temperature at the second position includes determined the expected temperature at the second position based on the first calculated relative temperature and the second calculated relative temperature.

In a fifth embodiment, with reference to the fourth embodiment, the first position and the third position are at a motherboard of the electronic device, and the second position is at a housing of the electronic device.

In a sixth embodiment, with reference to the first embodiment, controlling the at least one component includes increasing a speed of at least one fan, decreasing an operating frequency of the processor, decreasing an operating frequency of at least one heat generating component of the electronic device, or any combination thereof.

In a seventh embodiment, with reference to the first embodiment, calculating the relative temperature for the second position includes identifying at least two predetermined values for a linear correlation between the determined temperature at the first position and the calculated relative temperature for the second position. Calculating the relative temperature for the second position also includes calculating the relative temperature for the second position based on the determined temperature at the first position and the at least two identified predetermined values.

In an eighth embodiment, with reference to the seventh embodiment, the method further includes storing, by a memory, pairs of predetermined values. Each of the pairs of predetermined values represents a respective correlation of the temperature at the first position with the relative temperature for the second position. Each of the correlations corresponds to a respective operating condition of the electronic device. Identifying the at least two predetermined values includes identifying one of the pairs of predetermined values stored in the memory based on a current operating condition of the electronic device.

In a ninth embodiment, with reference to the eighth embodiment, the method further includes generating the pairs of predetermined values based on experimental data, simulation data, or a combination thereof.

In a tenth embodiment, with reference to the seventh embodiment, the at least two predetermined values include a slope and an offset for the linear correlation.

In an eleventh embodiment, a computing device includes a sensor located at a first position and associated with a second position different than the first position. The sensor is operable to determine a temperature at the first position. The computing device also includes a processor in communication with the sensor. The processor is configured to calculate a temperature for the second position based on the determined temperature at the first position and at least two predetermined values. The processor is also configured to compare the calculated temperature for the second position to a predetermined value for the second position. The processor is configured to generate a control signal for at least one component within the computing device when the calculated temperature for the second position is greater than, or greater than or equal to the predetermined values for the second position.

In a twelfth embodiment, with reference to the eleventh embodiment, the at least one component includes at least one fan, the processor, at least one heat generating component of the computing device, or any combination thereof. The control signal instructs the at least one fan to increase in speed, instructs the processor to decrease a frequency at which the processor operates, instructs the at least one heat generating component to decrease a frequency at which the at least one heat generating component operates, or any combination thereof.

In a thirteenth embodiment, with reference to the eleventh embodiment, the computing device further includes a housing that supports the sensor and the processor. The first position is within the housing, and the second position is at the housing.

In a fourteenth embodiment, with reference to the eleventh embodiment, the at least two predetermined values represent a slope and an offset for a linear correlation between the determined temperature at the first position and the calculated temperature for the second position.

In a fifteenth embodiment, with reference to the eleventh embodiment, the sensor is operable to determine the temperature at the first position at a plurality of time points. The plurality of time points include a first time point and a second time point. The calculation of the temperature for the second position includes calculation of an average temperature for the second position based on the determined temperature at the first position at the first time point and the second time point.

In a sixteenth embodiment, a system includes a computing device. The computing device includes a housing, a sensor, and a fan, a heat generating component, or the fan and the heat generating component. The sensor is located at a first position and is associated with a second position different than the first position. The sensor is operable to determine a temperature at the first position. The first position is within the housing, and the second position is at the housing. The fan, the heat generating component, or the fan and the heat generating component are supported by the housing. The system also includes a processor in communication with the sensor. The processor is configured to calculate a temperature for the second position based on the determined temperature at the first position and at least two predetermined values. The processor is also configured to compare the calculated temperature for the second position to a predetermined value for the second position. The processor is configured to increase a speed of the fan, decrease an operating frequency of the heat generating component, decrease an operating frequency of the processor, or any combination thereof when the calculated temperature for the second position is greater than, or greater than or equal to the predetermined value for second position.

In a seventeenth embodiment, with reference to the sixteenth embodiment, the computing device further includes the processor.

In an eighteenth embodiment, with reference to the sixteenth embodiment, the system further includes a memory in communication with the processor. The memory is configured to store pairs of predetermined values representing a respective correlation of the temperature at the first position with the temperature for the second position. Each of the correlations corresponds to a respective operating condition for the computing device.

In a nineteenth embodiment, with reference to the eighteenth embodiment, the calculation of the temperature for the second position includes identification of one of the pairs of predetermined values stored in the memory based on a current operating condition of the electronic device. The one identified pair of predetermined values represents a slope and an offset for a linear correlation between the determined temperature at the first position and the calculated temperature for the second position.

In a twentieth embodiment, with reference to the sixteenth embodiment, the sensor is operable to determine the temperature at the first position at a plurality of time points. The plurality of time points include a first time point and a second time point. The calculation of the temperature for the second position includes calculation of an average temperature for the second position based on the determined temperature at the first position at the first time point and the second time point.

In connection with any one of the aforementioned embodiments, the thermal management device or the method for manufacturing the thermal management device may alternatively or additionally include any combination of one or more of the previous embodiments.

The foregoing description is given for clearness of understanding only, and no unnecessary limitations should be understood therefrom, as modifications within the scope of the claims may be apparent to those having ordinary skill in the art.

1. A method for cooling an electronic device, the method comprising:
determining, by a sensor of the electronic device located at a first position and associated with a second position, a temperature at the first position;
calculating, by a processor in communication with the sensor, a relative temperature for the second position based on the determined temperature at the first position;
determining, by the processor, an expected temperature at the second position based on the calculated relative temperature for the second position;
comparing the determined expected temperature at the second position to a predetermined temperature for the second position; and
controlling at least one component of the electronic device when the determined expected temperature for the second position is greater than the predetermined temperature for the second position.

2. The method of claim 1, wherein the determined temperature at the first position is a first temperature determined at a first time point,
wherein the method further comprises determining, by the sensor, a second temperature at the first position at a second time point, the second time point being after the first time point,
wherein determining the expected temperature at the second position comprises calculating, by the processor, an average temperature for the second position based on the first temperature and the second temperature at the first position.

3. The method of claim 2, wherein calculating the average temperature for the second position comprises calculating an exponential weighted moving average for the second position.

4. The method of claim 1, wherein the sensor is a first sensor, and the calculated relative temperature is a first calculated relative temperature,
wherein the method further comprises:
determining, by a second sensor of the electronic device located at a third position and associated with the second position, a temperature at the third position; and
calculating a second relative temperature for the second position based on the determined temperature at the third position, and
wherein determining the expected temperature at the second position comprises determining the expected temperature at the second position based on the first calculated relative temperature and the second calculated relative temperature.

5. The method of claim 4, wherein the first position and the third position are at a motherboard of the electronic device, and the second position is at a housing of the electronic device.

6. The method of claim 1, wherein controlling the at least one component comprises increasing a speed of at least one fan, decreasing an operating frequency of the processor, decreasing an operating frequency of at least one heat generating component of the electronic device, or any combination thereof.

7. The method of claim 1, wherein calculating the relative temperature for the second position comprises:
identifying at least two predetermined values for a linear correlation between the determined temperature at the first position and the calculated relative temperature for the second position; and
calculating the relative temperature for the second position based on the determined temperature at the first position and the at least two identified predetermined values.

8. The method of claim 7, further comprising storing, by a memory, pairs of predetermined values, each of the pairs of predetermined values representing a respective correlation of the temperature at the first position with the relative temperature for the second position, each of the correlations corresponding to a respective operating condition of the electronic device,
wherein identifying the at least two predetermined values comprises identifying one of the pairs of predetermined values stored in the memory based on a current operating condition of the electronic device.

9. The method of claim 8, further comprising generating the pairs of predetermined values based on experimental data, simulation data, or a combination thereof.

10. The method of claim 7, wherein the at least two predetermined values comprise a slope and an offset for the linear correlation.

11. A computing device comprising:
a sensor located at a first position and being associated with a second position different than the first position, the sensor being operable to determine a temperature at the first position; and
a processor in communication with the sensor, the processor being configured to:
calculate a temperature for the second position based on the determined temperature at the first position and at least two predetermined values;
compare the calculated temperature for the second position to a predetermined value for the second position; and
generate a control signal for at least one component within the computing device when the calculated temperature for the second position is greater than, or greater than or equal to the predetermined value for the second position.

12. The computing device of claim 11, wherein the at least one component comprises at least one fan, the processor, at least one heat generating component of the computing device, or any combination thereof, and
wherein the control signal instructs the at least one fan to increase in speed, instructs the processor to decrease a frequency at which the processor operates, instructs the at least one heat generating component to decrease a frequency at which the at least one heat generating component operates, or any combination thereof.

13. The computing device of claim 11, further comprising a housing that supports the sensor and the processor,
wherein the first position is within the housing, and the second position is at the housing.

14. The computing device of claim 11, wherein the at least two predetermined values represent a slope and an offset for a linear correlation between the determined temperature at the first position and the calculated temperature for the second position.

15. The computing device of claim 11, wherein the sensor is operable to determine the temperature at the first position at a plurality of time points, the plurality of time points comprising a first time point and a second time point, and
wherein the calculation of the temperature for the second position comprises calculation of an average temperature for the second position based on the determined temperature at the first position at the first time point and the second time point.

16. A system comprising:
a computing device comprising:
a housing;
a sensor located at a first position and being associated with a second position different than the first position, the sensor being operable to determine a temperature at the first position, the first position being within the housing and the second position being at the housing; and
a fan, a heat generating component, or the fan and the heat generating component, the fan, the heat generating component, or the fan and the heat generating component being supported by the housing; and
a processor in communication with the sensor, the processor being configured to:
calculate a temperature for the second position based on the determined temperature at the first position and at least two predetermined values; and
compare the calculated temperature for the second position to a predetermined value for the second position,
wherein the processor is configured to increase a speed of the fan, decrease an operating frequency of the heat generating component, decrease an operating frequency of the processor, or any combination thereof when the calculated temperature for the second position is greater than, or greater than or equal to the predetermined value for the second position.

17. The system of claim 16, wherein the computing device further comprises the processor.

18. The system of claim 16, further comprising a memory in communication with the processor, the memory configured to store pairs of predetermined values representing a respective correlation of the temperature at the first position with the temperature for the second position, each of the correlations corresponding to a respective operating condition for the computing device.

19. The system of claim 18, wherein the calculation of the temperature for the second position comprises identification of one of the pairs of predetermined values stored in the memory based on a current operating condition of the electronic device, and
wherein the one identified pair of predetermined values represents a slope and an offset for a linear correlation between the determined temperature at the first position and the calculated temperature for the second position.

20. The system of claim 16, wherein the sensor is operable to determine the temperature at the first position at a plurality of time points, the plurality of time points comprising a first time point and a second time point, and
wherein the calculation of the temperature for the second position comprises calculation of an average temperature for the second position based on the determined temperature at the first position at the first time point and the second time point.
